(19) United States
(12) Patent Application Publication
(10) Pub. No.: US 2026/0110873 A1
(43) Pub. Date: Apr. 23, 2026

(54) LENS ASSEMBLY

(71) Applicant: Samsung Electro-Mechanics Co., Ltd., Suwon-si (KR)

(72) Inventors: In Do SEO, Suwon-si (KR); Dong Shin YANG, Suwon-si (KR)

(73) Assignee: Samsung Electro-Mechanics Co., Ltd., Suwon-si (KR)

(21) Appl. No.: 19/317,813

(22) Filed: Sep. 3, 2025

(30) Foreign Application Priority Data
Oct. 21, 2024 (KR) 10-2024-0144250
Apr. 9, 2025 (KR) 10-2025-0046210

(51) Int. Cl. G02B 7/02

(52) U.S. Cl. CPC G02B 7/021

(57) ABSTRACT

A lens assembly includes a lens including an optical portion refracting light, and a flange portion extending along a periphery of the optical portion, a spacer in contact with the flange portion in an optical axis direction, and a lens barrel accommodating the lens and the spacer. A distance from an optical axis to a contact point between the flange portion and the spacer is less than a maximum radius of the optical portion. The periphery of the optical portion includes an edge portion and a connection portion. In a cross-sectional view passing through the optical axis and the connection portion, the lens is spaced apart from the spacer.

### CROSS-REFERENCE TO RELATED APPLICATIONS

This application claims the benefit under 35 USC 119(a) of Korean Patent Application Nos. 10-2024-0144250 filed on Oct. 21, 2024, and 10-2025-0046210 filed on Apr. 9, 2025, in the Korean Intellectual Property Office, the entire disclosures of which are incorporated herein by reference for all purposes.

### BACKGROUND

### 1. Field

The present disclosure relates to a lens assembly.

### 2. Description of the Background

Camera modules have been used in portable electronic devices such as smartphones. With the recent trend toward a reduction in size of portable electronic devices, there is demand for a reduction in the size of camera modules that may be mounted in portable electronic devices. In addition, regardless of the need for size reduction, there is also demand for improved performance of camera modules. Accordingly, research is required to reduce the size of camera modules while maintaining performance of camera modules.

Generally, an image sensor of a camera module may have a rectangular shape, and a lens refracting light may have a circular shape. Accordingly, not all light refracted by the lens may form an image on the image sensor. In this regard, it is possible to consider reducing a size of the lens by removing an unnecessary portion thereof, thereby reducing an overall size of the camera module. For example, a lens having a shape in which portions of both side surfaces of a circular lens are removed (hereinafter, referred to as a “D-cut lens”) may be used.

When assembling a plurality of lenses in a lens barrel, there is a demand for a lens assembly structure having simplified assembly between lenses or between a lens and a spacer, and is advantageous for size reduction.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes a lens including an optical portion refracting light, and a flange portion extending along a periphery of the optical portion, a spacer in contact with the flange portion in an optical axis direction, and a lens barrel accommodating the lens and the spacer. A distance from an optical axis to a contact point between the flange portion and the spacer is less than a maximum radius of the optical portion. The periphery of the optical portion includes an edge portion and a connection portion. In a cross-sectional view passing through the optical axis and the connection portion, the lens is spaced apart from the spacer.

The flange portion may extend from the edge portion, and may be spaced apart from the connection portion.

The flange portion may include sub-portions, the edge portion may include sub-portions, and the connection portion may include sub-portions, each flange sub-portion may extend from a corresponding edge sub-portion, and each flange sub-portion may be spaced apart from neighboring flange sub-portions by a connection sub-portion of the connection sub-portions.

The optical portion may have a non-circular shape in a view along the optical axis direction.

A curvature of the edge portion may be less than a curvature of the connection portion.

The edge portion may have a linear shape in a view along the optical axis direction.

The connection portion may have an arc shape in a view along the optical axis direction.

The edge portion may include first and second edge portions opposing each other in a short axis direction of the optical portion, and third and fourth edge portions opposing each other in a long axis direction, perpendicular to the short axis direction.

The spacer may be in contact with a flange portion extending from each of the first and second edge portions, and may be spaced apart from a flange portion extending from each of the third and fourth edge portions.

The spacer may be in contact with a flange portion extending from each of the third and fourth edge portions, and may be spaced apart from a flange portion extending from each of the first and second edge portions.

The spacer may be in contact with a flange portion extending from each of the first to fourth edge portions.

The connection portion may include a first connection portion connecting the first and third edge portions to each other, a second connection portion connecting the second and third edge portions to each other, a third connection portion connecting the second and fourth edge portions to each other, and a fourth connection portion connecting the first and fourth edge portions to each other.

Each of the first to fourth connection portions may be spaced apart from the spacer.

In another general aspect, a lens assembly includes a lens barrel, a plurality of lenses laminated in an optical axis direction within the lens barrel, and a spacer disposed between two adjacent lenses, among the plurality of lenses. A periphery of at least one lens, among the two lenses, includes a linear-shaped edge portion and an arc-shaped connection portion. The spacer is in contact with the edge portion and is spaced apart from the connection portion in the optical axis direction. A shortest distance from a contact point between the edge portion and the spacer to the optical axis is less than a maximum effective radius of the at least one lens.

The at least one lens may be a lens having a largest effective diameter, among the plurality of lenses.

The at least one lens may be a lens closest to an image side, among the plurality of lenses.

Other features and aspects will be apparent from the following detailed description, the drawings, and the claims.

### BRIEF DESCRIPTION OF DRAWINGS

FIG. 1 is a perspective view of a lens assembly according to a first example embodiment of the present disclosure.

FIG. 2 is an exploded perspective view of a lens assembly according to a first example embodiment of the present disclosure.

FIG. 3 is a front view of a lens and a spacer of a lens assembly according to a first example embodiment of the present disclosure.

FIG. 4 is a cross-sectional view taken along line I-I′ of FIG. 1.

FIG. 5 is an enlarged view of region “A”of FIG. 4.

FIG. 6 is a cross-sectional view taken along line II-II′ of FIG. 1.

FIG. 7 is an enlarged view of region “B1”of FIG. 6.

FIG. 8 is a cross-sectional view taken along line III-III′ of FIG. 1.

FIG. 9 is an enlarged view of region “C1”of FIG. 8.

FIG. 10 is a front view of a lens and a spacer of a lens assembly according to a second example embodiment of the present disclosure.

FIG. 11 is a cross-sectional view of a lens assembly in a short axis direction according to a second example embodiment of the present disclosure, corresponding to FIG. 6.

FIG. 12 is an enlarged view of region “B2”of FIG. 11.

FIG. 13 is a cross-sectional view of a lens assembly in a long axis direction according to a second example embodiment of the present disclosure, corresponding to FIG. 8.

FIG. 14 is an enlarged view of region “C2”of FIG. 13.

FIG. 15 is a front view of a lens and a spacer of a lens assembly according to a third example embodiment of the present disclosure.

FIG. 16 is a cross-sectional view of a lens assembly in a short axis direction according to a third example embodiment of the present disclosure, corresponding to FIG. 6.

FIG. 17 is an enlarged view of region “B3”of FIG. 16.

FIG. 18 is a cross-sectional view of a lens assembly in a long axis direction according to a third example embodiment of the present disclosure, corresponding to FIG. 8.

FIG. 19 is an enlarged view of region “C3” of FIG. 18.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Unless otherwise specified, a component included in one example embodiment disclosed herein may also be included in other example embodiments.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An effective aperture radius of a lens surface is a radius of a portion of the lens surface through which light actually passes, and is not necessarily a radius of an outer edge of the lens surface. An object-side surface of a lens and an image-side surface of the lens may have different effective aperture radiuses.

Stated another way, an effective aperture radius of a lens surface is a distance in a direction perpendicular to an optical axis of the lens surface between the optical axis of the lens surface and a marginal ray of light passing through the lens surface. An effective aperture diameter (effective diameter) of a lens is twice the effective aperture radius.

An aspect of the present disclosure may be to reduce a size of a lens assembly by supporting a lens through an assembly structure formed only in regions of the lens opposing each other in a short axis direction and/or a long axis direction.

Another aspect of the present disclosure may be to secure a maximum area of an effective diameter of a lens within a limited size.

According to one or more example embodiments, a lens assembly may be provided in a camera module mounted in a portable electronic device.

In the present disclosure, the portable electronic device may refer to a portable electronic device such as a mobile communication terminal, a smartphone, a tablet PC, or the like.

A lens assembly 1000 according to an example embodiment may include a non-circular lens. A lens L of the present example embodiment may include an edge portion 110 having a linear shape by partially removing a side surface thereof. In the lens assembly 1000 of the present example embodiment, a support structure for fixing the lens L may be disposed only on the edge portion 110, and may not be disposed on a connection portion 120 having an arc shape, thereby securing an effective diameter 2×r1. That is, a lens region for image formation may be maximized while the lens L is stably accommodated in a lens barrel 300.

Hereinafter, detailed components of the lens assembly 1000 according to one or more example embodiments will be described in detail with reference to the drawings.

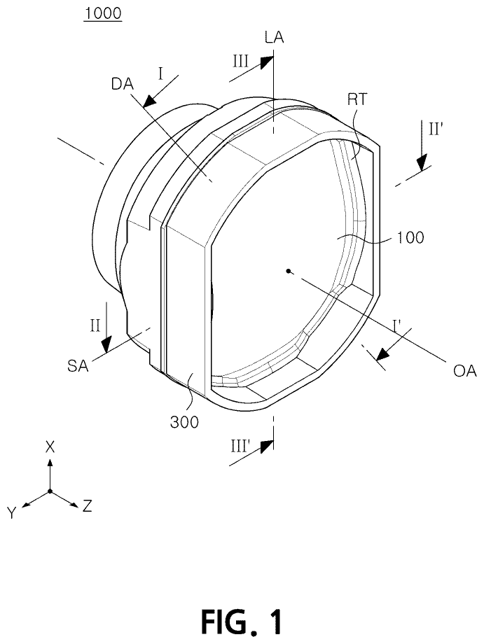

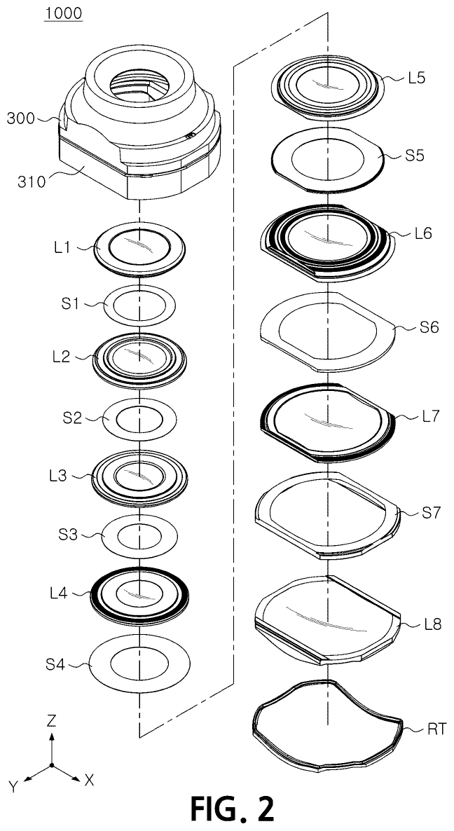

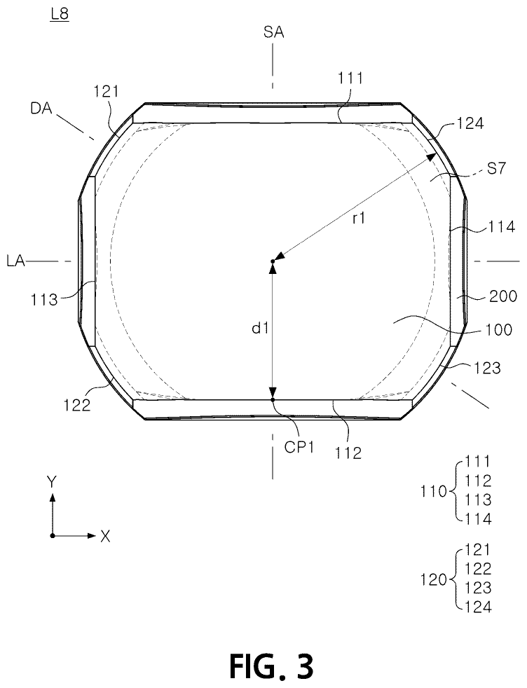

FIG. 1 is a perspective view of the lens assembly 1000 according to a first example embodiment of the present disclosure. FIG. 2 is an exploded perspective view of the lens assembly 1000 according to the first example embodiment of the present disclosure. FIG. 3 is a front view of a lens L8 and a spacer S7 according to the first example embodiment of the present disclosure.

Referring to FIGS. 1 to 3, the lens assembly 1000 according to one or more example embodiments of the present disclosure may include a lens L, a spacer S, and a lens barrel 300 accommodating the lens L and the spacer S.

The lens L of the present example embodiment may include an optical portion 100 refracting light, and a flange portion 200 extending along a portion of a periphery of the optical portion 100. The spacer S of the present example embodiment may be disposed to be in contact with the flange portion 200 in an optical axis direction OA.

In addition, the lens may be a plurality of lenses. The plurality of lenses may be aligned in a Z-axis direction, that is, in the optical axis direction OA, within the lens barrel 300.

The plurality of lenses may include a first lens L1, a second lens L2, a third lens L3, a fourth lens L4, a fifth lens L5, a sixth lens L6, a seventh lens L7, and an eighth lens L8 arranged from an object side toward an image side (an image sensor side). However, the number of lenses is not limited thereto, and seven or fewer or nine or more lenses may be included, as necessary.

A spacer may be disposed between adjacent lenses. The spacer may maintain a distance between the lenses. For example, the spacer may include a first spacer S1, a second spacer S2, a third spacer S3, a fourth spacer S4, a fifth spacer S5, a sixth spacer S6, and a seventh spacer S7 arranged from the object side toward the image side (the image sensor side).

In addition, the lens assembly 1000 of the present example embodiment may include a retainer RT fixing the eighth lens L8, closest to the image side (image sensor side), to the inside of the lens barrel 300. The eighth lens L8 may be fixed to the lens barrel 300 using the retainer RT, such that the plurality of lenses may be accommodated in the lens barrel 300. The retainer RT may also have a function of blocking unnecessary stray light, such as light reflected from an internal surface of the lens barrel 300, but the present disclosure is not limited thereto.

Among the plurality of lenses, four lenses L5, L6, L7, and L8 disposed to close to the image side, may be lenses including the edge portion 110 and the connection portion 120 (see the lens of FIG. 3), and four lenses L1, L2, L3, and L4 disposed to be close to the object side may be circular lenses.

That is, the four lenses L5, L6, L7, and L8, disposed to be close to the image side, and the four lenses L1, L2, L3, and L4, disposed to be close to the object side, may have different shapes.

The four lenses L1, L2, L3, and L4, disposed to be close to the object side, may also be injection-molded. Accordingly, a D-cut portion may be formed on a portion of each lens due to removal of a gate portion, a passage into which a resin is introduced. However, the four lenses L1 to L4 may be generally circular lenses.

The lens barrel 300 may include a D-cut portion 310 formed on a portion to which the four lenses L5, L6, L7, and L8 disposed to be close to the image side are coupled. In the portion on which the D-cut portion 310 is formed, an internal surface and an external surface of the lens barrel 300 may have flat surfaces.

The lens assembly 1000 used in the portable electronic device may generally have a short total track length (TTL) for size reduction. Here, the TTL may be a distance from an object-side surface of the first lens L1 to an imaging plane of an image sensor.

Instead of reducing the TTL, to secure optical performance, a diameter of the optical portion 100 may increase as the plurality of lenses become closer to the image side. Here, the optical portion 100 may refer to a region refracting light, and a maximum diameter of the optical portion 100 may be defined as an effective diameter.

The lens assembly 1000 according to an example embodiment of the present disclosure may include at least one of four lenses L5, L6, L7, and L8, disposed to be close to the image side, having an edge portion 110 formed to be symmetrical with respect to an optical axis OA. Specifically, a first edge portion 111 and a second edge portion 112 may be formed to oppose each other in a direction of a short axis SA, and a third edge portion 113 and a fourth edge portion 114 may be formed to oppose each other in a direction of a long axis LA. Here, the short axis SA may refer to an axis having a shortest diameter while passing through the optical axis in the lens, and may be parallel to a Y-axis in the drawings. In addition, the long axis LA may be an axis perpendicular to the short axis SA, and may be parallel to an X-axis in the drawings.

The D-cut portion 310 may be formed on the lens barrel 300 at a position corresponding to that of the edge portion 110 of the lens, thereby reducing an overall size of the lens assembly 1000. Accordingly, it may be advantageous for reducing a size of the camera module.

In describing the present example embodiment, the eighth lens L8 that has a largest effective diameter and is closest to the image side (the image sensor side), will be described. When a D-cut shape is applied to a lens that has a largest effective diameter and is closest to the image side, the size and weight of the lens assembly 1000 may be further reduced.

However, the present example embodiment is not limited thereto, and features of the present example embodiment may be applied to another lens having a D-cut shape, for example, the seventh lens L7 or the like. In the present example embodiment, a single lens or a plurality of lenses having a D-cut shape may be accommodated in the lens barrel 300.

In addition, the spacer is also described with reference to the seventh spacer S7 between the eighth lens L8 and the seventh lens L7. However, when a reference lens varies, the same configuration may be applied to another spacer adjacent to the lens, such as the sixth spacer S6.

Referring to FIG. 3, the lens L8 of the present example embodiment may include an optical portion 100 and a flange portion 200.

The optical portion 100 may be a portion exhibiting optical performance of the lens L8. For example, light reflected from a subject may be refracted while passing through the optical portion 100.

The optical portion 100 may have positive or negative refractive power, and may have a spherical or aspherical shape.

In addition, the optical portion 100 may include an object-side surface (a surface toward the object side) and an image-side surface (a surface toward the image side). The object-side surface may be convex, and the image-side surface may be concave or convex.

The flange portion 200 may be a portion fixing the lens L8 to another component, for example, the lens barrel 300 or another adjacent lens.

The flange portion 200 may extend from a portion of a periphery of the optical portion 100, and may be integrally formed with the optical portion 100.

Referring to FIG. 3, the optical portion 100 and the flange portion 200 may be formed to have a non-circular shape. For example, the optical portion 100 and the flange portion 200 may have a non-circular shape when viewed from the direction of the optical axis OA.

The periphery of the optical portion 100 may include an edge portion 110 and a connection portion 120.

A curvature of the edge portion 110 may be less than that of the connection portion 120. For example, when viewed from the direction of the optical axis OA, the edge portion 110 may have a linear shape. Here, the linear shape may refer to not only an exactly linear shape, but also a curvature close to zero or a generally linear shape.

The edge portion 110 of the present example embodiment may include a first edge portion 111 and a second edge portion 112 opposing each other in the direction of the short axis SA of the optical portion 100, and a third edge portion 113 and a fourth edge portion 114 opposing each other in the direction of the long axis LA of the optical portion 100 (edge sub-portions). Here, the short axis SA may refer to an axis having a shortest diameter while passing through the optical axis in the lens, and may be parallel to the Y-axis in the drawings. In addition, the long axis LA may be an axis perpendicular to the short axis SA, and may be parallel to the X-axis in the drawings.

In other words, in the lens L of the present example embodiment, a pair of D-cuts may be formed on the optical portion 100 in the direction of the short axis SA, and a pair of D-cuts may be formed on the optical portion 100 in the direction of the long axis LA, such that a total of two pairs of D-cuts may be formed. Thus, the edge portion 110 may be formed on four side surfaces. However, the present disclosure is not limited thereto, and a pair of D-cut portions may be formed on the optical portion 100, and thus the edge portion 110 may be formed on two side surfaces.

The connection portion 120 may be a region connecting two edge portions 110 to each other. Specifically, the connection portion 120 may include a first connection portion 121 connecting the first edge portion 111 and the third edge portion 113 to each other, a second connection portion 122 connecting the second edge portion 112 and the third edge portion 113 to each other, a third connection portion 123 connecting the second edge portion 112 and the fourth edge portion 114 to each other, and a fourth connection portion 124 connecting the first edge portion 111 and the fourth edge portion 114 to each other (connection sub-portions).

The connection portion 120 may correspond to an arc shape when viewed from the direction of the optical axis OA. That is, the connection portion 120 may be a region of the optical portion 100 on which a D-cut is not formed.

As used herein, the lens L8 having the above shape may be referred to as a “D-cut lens.”

Referring to FIG. 3, the flange portion 200 may be disposed to extend from the edge portion 110. Specifically, the flange portion 200 may extend from each of the first edge portion 111 and the second edge portion 112 in the direction of the short axis SA. In addition, the flange portion 200 may extend from the third edge portion 113 and the fourth edge portion 114 in the direction of the long axis LA. Each portion of the flange portion 200 extending from an edge sub-portion may be referred to as a flange sub-portion.

The flange portion 200 may be disposed to be spaced apart from the connection portion 120. Specifically, the flange portion 200 may be disposed in the directions of the short axis SA and the long axis LA, and may not be disposed in a direction of a diagonal axis DA between the short axis SA and the long axis LA. For example, each flange sub-portion extending from a corresponding edge sub-portion may be spaced apart from neighboring flange sub-portions by a connection sub-portion. Here, the diagonal axis DA may refer to an axis passing through all of the optical axis OA, the first connection portion 121, and the third connection portion 123. Alternatively, the diagonal axis DA may refer to an axis passing through all of the optical axis OA, the second connection portion 122, and the fourth connection portion 124.

The lens L8 of the present example embodiment may be formed of a plastic material, and may be injection-molded through a mold. Here, the lens L8 of the present example embodiment may not be formed by cutting a portion of the lens after injection molding, but may be manufactured to have the above-described shape in the injection molding operation.

In general, the lens may have a generally circular shape, and the image sensor of the camera module has a rectangular shape. Accordingly, not all light refracted by the circular lens may form an image on the image sensor.

Accordingly, a size of the lens may be reduced by removing an unnecessary portion of the optical portion 100 of the lens, thereby reducing a size of the camera module.

However, when a portion of the lens is removed after injection molding, the lens may be deformed by force applied to the lens in such a process. When the lens is deformed, optical performance of the lens may inevitably change.

However, in the lens L8 of the present example embodiment, the optical portion 100 and the flange portion 200 of the lens L8 may be molded to have a non-circular shape during injection, such that a size of the lens L8 may be reduced, and performance of the lens L8 may not be degraded.

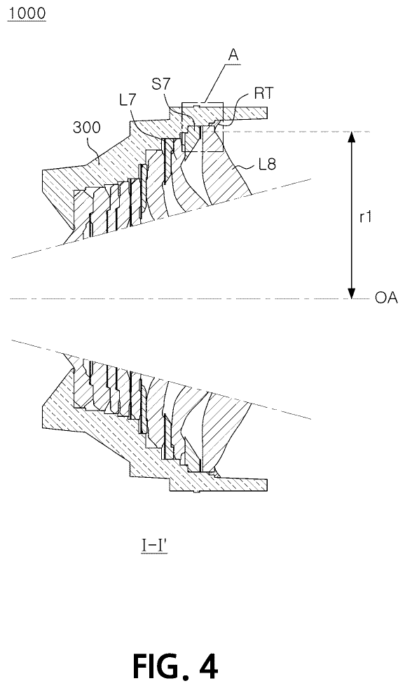

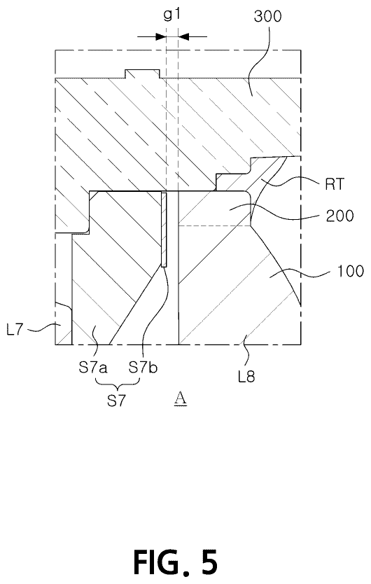

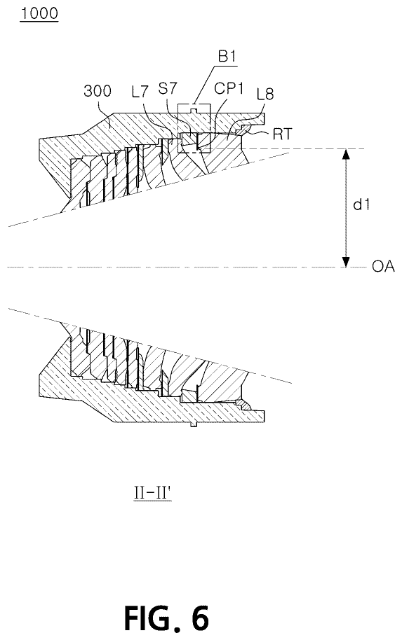

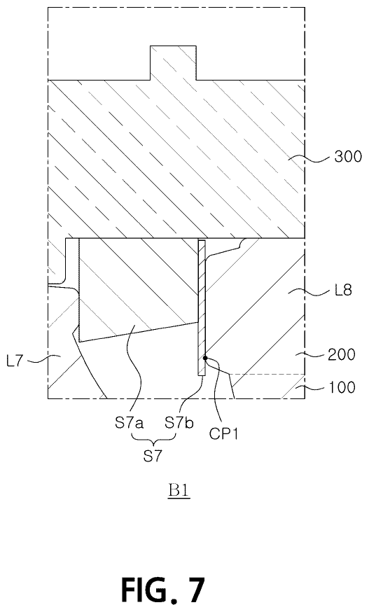

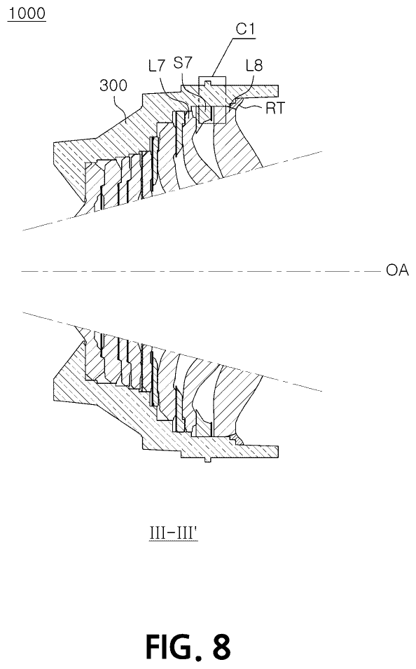

FIG. 3 is a front view of the lens L8 and the spacer S7 of a lens assembly according to the first example embodiment of the present disclosure. FIG. 4 is a cross-sectional view taken along line I-I′ of FIG. 1. FIG. 5 is an enlarged view of region “A” of FIG. 4. FIG. 6 is a cross-sectional view taken along line II-II′ of FIG. 1. FIG. 7 is an enlarged view of region “B1” of FIG. 6. FIG. 8 is a cross-sectional view taken along line III-III′ of FIG. 1.

Referring to FIGS. 3 to 9, in the lens assembly 1000 of the present example embodiment, the lens L8 may be supported in the direction of the short axis SA, and may not be supported in the directions of the long axis LA and/or the diagonal axis DA. That is, in the lens L8 of the present example embodiment, a point of the lens L8 that is in direct contact with the spacer S7 and is supported by the spacer S7 may be formed only in the direction of the short axis SA.

Accordingly, in the lens assembly 1000 of the present example embodiment, a distance d1 from the optical axis OA to a point CP1 at which the flange portion 200 and the spacer S7 are in contact with each other may be less than a maximum radius r1 of the optical portion 100. The maximum radius r1 of the optical portion 100 may correspond to ½ of an effective diameter of the optical portion 100, and may correspond to a maximum distance from the optical axis OA to the connection portion 120.

As described, the lens assembly 1000 of the present example embodiment may form a structure for assembly within the lens barrel 300 only in the direction of the short axis DA, thereby securing a maximum effective diameter in a region of the connection portion 120, which may be advantageous for size reduction. That is, a region of the lens in which an image is not formed may be removed in consideration of a shape of the image sensor, and a region of the lens occupied by a component for assembly may be minimized.

Referring to FIGS. 4 and 5, the lens L8 may be spaced apart from the spacer S7 in a cross-sectional view passing through the optical axis OA and the connection portion 120. That is, the lens L8 and the spacer S7 may not be in contact with each other, and may be spaced apart from each other at a predetermined distance g1 in a cross-sectional view taken along the diagonal axis DA. That is, in the lens L8 of the present example embodiment, the first connection portion 121, the second connection portion 122, the third connection portion 123, and the fourth connection portion 124 of the optical portion 100 may be disposed to be spaced apart from the spacer S7 in the optical axis direction. Here, the spacer S7 may be a component including both a portion S7a for maintaining a space and a portion S7b for light blocking.

Referring to FIGS. 6 and 7, in a cross-sectional view passing through the optical axis OA, the first edge portion 111, and the second edge portion 112, the lens L8 may be in contact with the spacer S7 in the optical axis direction. That is, in a cross-sectional view taken along the short axis SA, the flange portion 200 of the lens L8 may be in contact with the spacer S7, and a contact point closest to the optical axis OA, among contact points, may be defined as CP1.

Referring to FIGS. 3, 4, and 6, the distance d1 from the optical axis OA to the contact point CP1 between the flange portion 200 and the spacer S7 may be less than the maximum radius r1 of the optical portion 100 of the lens L8, that is, an effective radius of the optical portion 100.

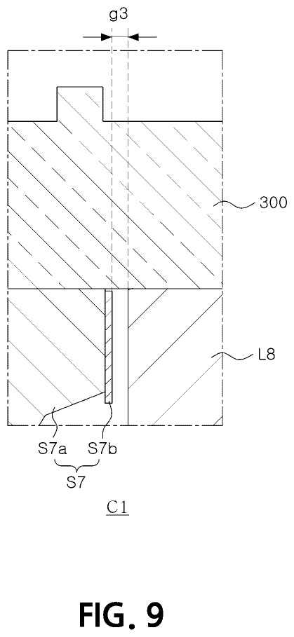

Referring to FIGS. 8 and 9, in a cross-sectional view passing through the optical axis OA, the third edge portion 113, and the fourth edge portion 114, the lens L8 may be spaced apart from the spacer S7 in the optical axis direction. Specifically, the spacer S7 may be spaced apart from the flange portion 200, extending from each of the third edge portion 113 and the fourth edge portion 114 in the direction of the long axis LA, by a predetermined distance g3. As described, a size of a support structure in the direction of the long axis LA may be reduced, and thus it may be more advantageous to reduce a size and weight of the lens assembly 1000.

Accordingly, in the lens assembly 1000 of the present example embodiment, the lens L8 may be stably supported by a support structure in the direction of the short axis SA, and a support structure in the direction of the diagonal axis DA may be omitted to secure the effective diameter of the optical portion 100. In addition, the size of the support structure in the direction of the long axis LA may be reduced, thereby further reducing the size and weight of the lens assembly 1000.

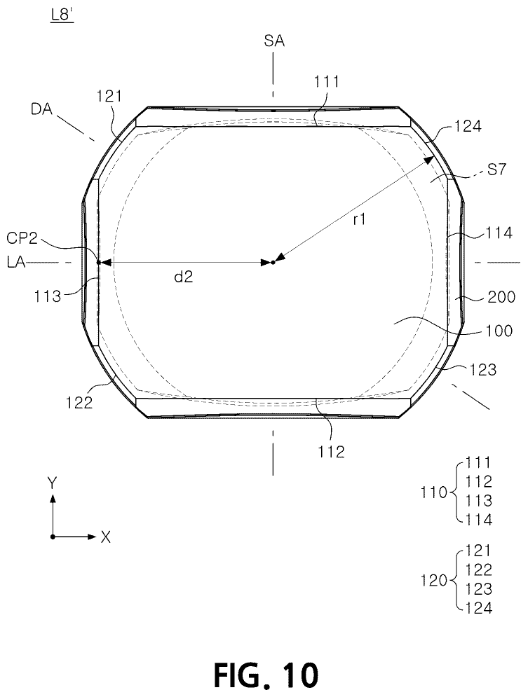

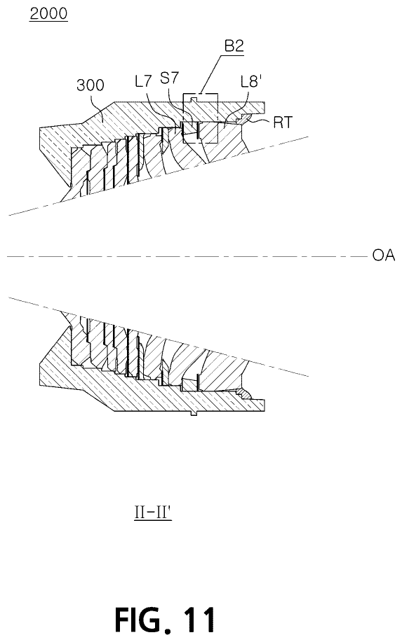

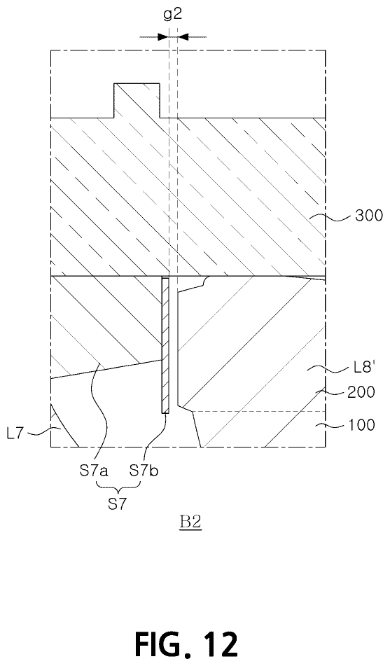

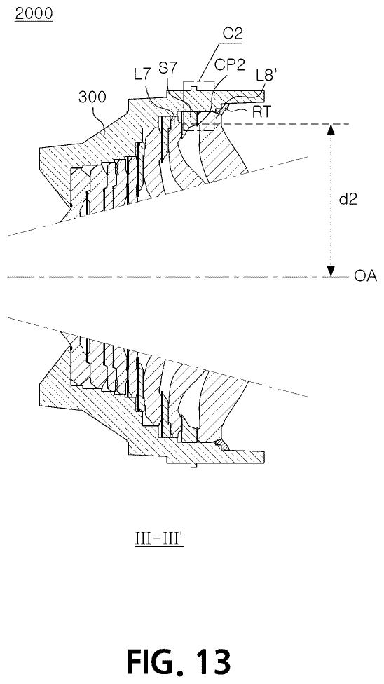

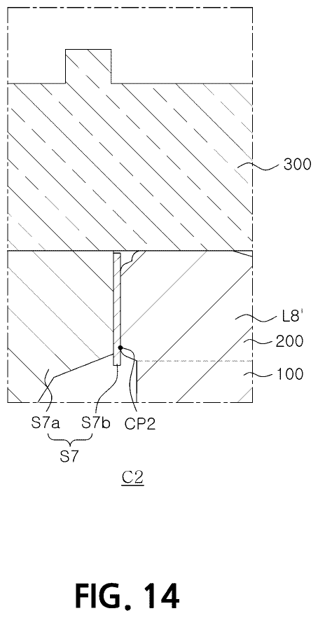

FIG. 10 is a front view of a lens L8′ and a spacer S7 of a lens assembly 2000 according to a second example embodiment of the present disclosure. FIG. 11 is a cross-sectional view of a lens assembly in a short axis direction according to the second example embodiment of the present disclosure, corresponding to FIG. 6. FIG. 12 is an enlarged view of region “B2” of FIG. 11. FIG. 13 is a cross-sectional view of a lens assembly in a long axis direction according to the second example embodiment of the present disclosure, corresponding to FIG. 8. FIG. 14 is an enlarged view of region “C2” of FIG. 13.

Comparing FIG. 10 with FIG. 3, the lens L8′ of the present example embodiment may be different from that of the first example embodiment in that the lens L8′ has a support structure in a direction of a long axis LA. The lens L8′ of the present example embodiment may be the same as that of the first example embodiment in that the lens L8′ does not have an assembly structure in a direction of a diagonal axis DA. Accordingly, only an assembly structure in a direction of a short axis SA and the direction of the long axis LA, which is a difference between the present example embodiment and the first example embodiment of the present disclosure, will be described, and descriptions of the first example embodiment of the present disclosure may be applied to remaining components in the same manner.

Referring to FIGS. 10 to 14, in the lens assembly 2000 of the present example embodiment, the lens L8′ may be supported in the direction of the long axis LA, and may not be supported in the direction of the short axis SA and the direction of the diagonal axis DA. That is, in the lens L8′ of the present example embodiment, a point of the lens L8′ that is in direct contact with the spacer S7 and is supported by the spacer S7 may be formed only in the direction of the long axis LA.

Accordingly, in the lens assembly 2000 of the present example embodiment, a distance d2 from an optical axis OA to a point CP2 at which a flange portion 200 and the spacer S7 are in contact with each other may be less than a maximum radius r1 of an optical portion 100. The maximum radius r1 of the optical portion 100 may correspond to ½ of an effective diameter of the optical portion 100, and may correspond to a maximum distance from the optical axis OA to a connection portion 120.

As described, the lens assembly 2000 of the present example embodiment may form a structure for assembly within a lens barrel 300 only in the direction of the long axis A, thereby securing a maximum effective diameter in a region of the connection portion 120, which may be advantageous for size reduction. That is, a region of the lens in which an image is not formed may be removed in consideration of a shape of an image sensor, and a region of the lens occupied by the assembly structure may be minimized.

Referring to FIGS. 10 to 12, in a cross-sectional view passing through the optical axis OA, a first edge portion 111, and a second edge portion 112, the lens L8′ may be spaced apart from the spacer S7 in the optical axis direction. Specifically, the spacer S7 may be spaced apart from a flange portion 200, extending from each of the first edge portion 111 and the second edge portion 112 in the direction of the short axis SA, by a predetermined distance g2. As described, a size of a support structure in the direction of the short axis SA may be reduced, and thus it may be more advantageous to reduce a size and weight of the lens assembly 2000.

Referring to FIGS. 10, 13, and 14, in a cross-sectional view passing through the optical axis OA, a third edge portion 113, and a fourth edge portion 114, the lens L8′ may be in contact with the spacer S7. That is, in a cross-sectional view taken along the long axis LA, the flange portion 200 of the lens L8′ may be in contact with the spacer S7, and a contact point closest to the optical axis OA, among contact points, may be defined as CP2.

The distance d2 from the optical axis OA to the contact point CP2 between the flange portion 200 and the spacer S7 may be less than the maximum radius r1 of the optical portion 100 of the lens L8′, that is, an effective radius of the optical portion 100.

Accordingly, in the lens assembly 2000 of the present example embodiment, the lens L8′ may be stably supported by a support structure in the direction of the long axis LA, and a support structure in the direction of the diagonal axis DA may be omitted to secure the effective diameter of the optical portion 100. In addition, the size of the support structure in the direction of the short axis SA may be reduced, thereby further reducing the size and weight of the lens assembly 2000.

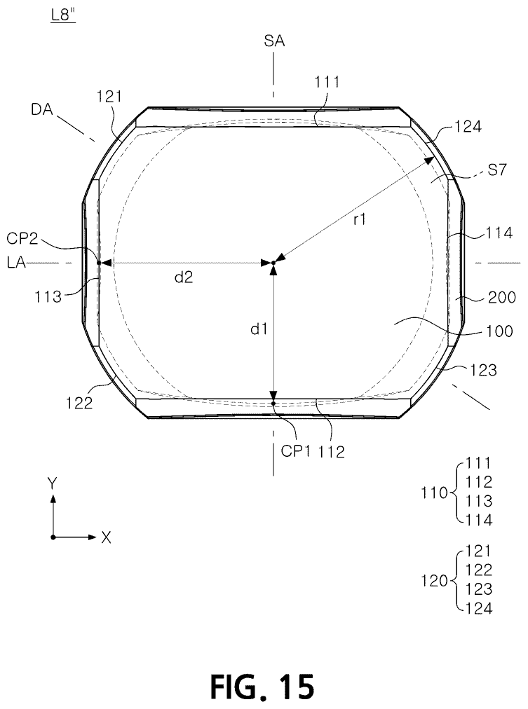

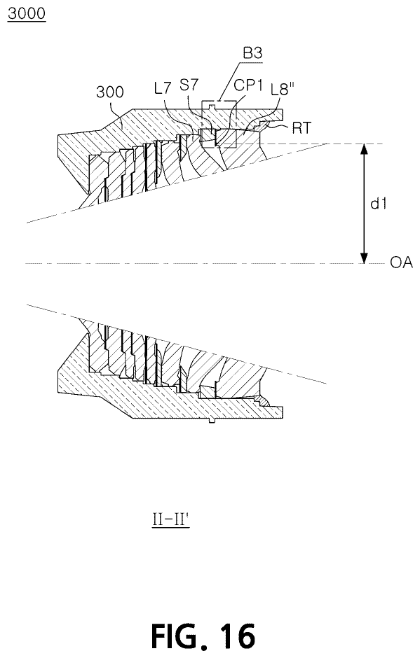

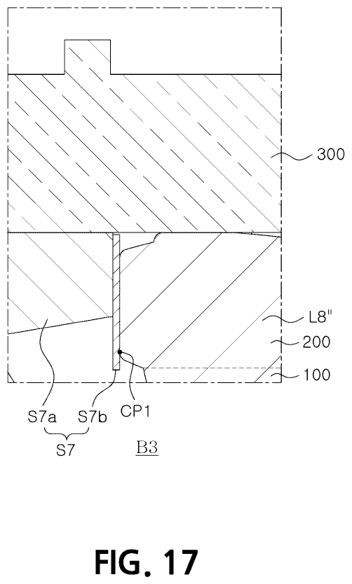

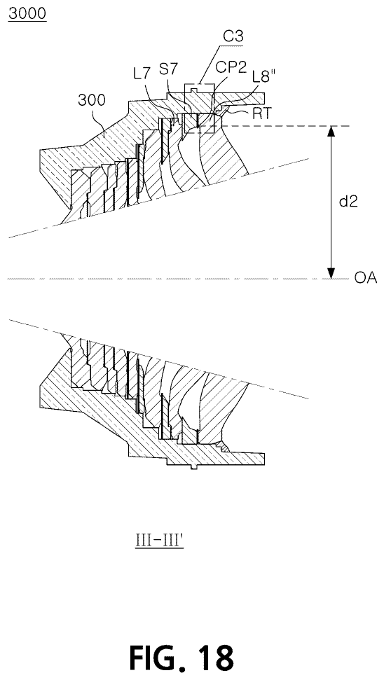

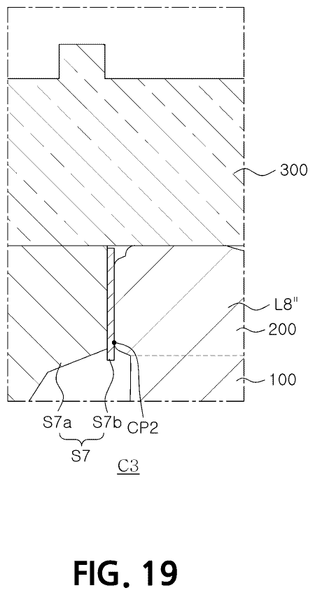

FIG. 15 is a front view of a lens L8″ and a spacer S7 of a lens assembly 3000 according to a third example embodiment of the present disclosure. FIG. 16 is a cross-sectional view of the lens assembly 3000 in a direction of a short axis SA according to the third example embodiment of the present disclosure, corresponding to FIG. 6. FIG. 17 is an enlarged view of region “B3” of FIG. 16. FIG. 18 is a cross-sectional view of the lens assembly in a direction of a long axis LA according to the third example embodiment of the present disclosure, corresponding to FIG. 8. FIG. 19 is an enlarged view of region “C3”of FIG. 18.

Comparing FIG. 15 with FIG. 3, the lens L8″ of the present example embodiment may be different from that of the first example embodiment in that the lens L8″ has a support structure in a direction of a short axis SA and a direction of a long axis LA. The lens L8″ of the present example embodiment may be the same as that of the first example embodiment in that the lens L8″ does not have an assembly structure in a direction of a diagonal axis DA. Accordingly, only an assembly structure in the direction of the short axis SA and the direction of the long axis LA, which is a difference between the present example embodiment and the first example embodiment of the present disclosure, will be described, and descriptions of the first example embodiment of the present disclosure may be applied to remaining components in the same manner.

Referring to FIGS. 15 to 19, in the lens assembly 3000 of the present example embodiment, the lens L8″ may be supported in each of the direction of the short axis SA and the direction of the long axis LA, and may not be supported in the direction of the diagonal axis DA. That is, a point of the lens L8″ of the present example embodiment that is in direct contact with the spacer S7 and is supported by the spacer S7 may be formed in each of the direction of the short axis SA and the direction of the long axis LA.

Accordingly, in the lens assembly 3000 of the present example embodiment, a distance d1 from the optical axis OA to a point CP1 at which a flange portion 200 and the spacer S7 are in contact with each other may be less than a maximum radius r1 of an optical portion 100. In addition, a distance d2 from the optical axis OA to a point CP2 at which the flange portion 200 and the spacer S7 are in contact with each other may be less than the maximum radius r1 of the optical portion 100. The maximum radius r1 of the optical portion 100 may correspond to ½ of an effective diameter of the optical portion 100, and may correspond to a maximum distance from the optical axis OA to a connection portion 120.

As described, the lens assembly 3000 of the present example embodiment may form a structure for assembly within a lens barrel 300 in each of the direction of the short axis SA and the direction of the long axis A, thereby securing a maximum effective diameter in a region of the connection portion 120, which may be advantageous for size reduction. That is, a region of the lens in which an image is not formed may be removed in consideration of a shape of an image sensor, and a region of the lens occupied by the assembly structure may be minimized.

Referring to FIGS. 15 to 17, in a cross-sectional view passing through the optical axis OA, a first edge portion 111, and a second edge portion 112, the lens L8″ may be in contact with the spacer S7. That is, in a cross-sectional view taken along the short axis SA, the flange portion 200 of the lens L8″ may be in contact with the spacer S7, and a contact point closest to the optical axis OA, among contact points, may be defined as CP1. The distance d1 from the optical axis OA to the contact point CP1 between the flange portion 200 and the spacer S7 may be less than the maximum radius r1 of the optical portion 100 of the lens L8″, that is, an effective radius of the optical portion 100.

Referring to FIGS. 15, 18, and 19, in a cross-sectional view passing through the optical axis OA, a third edge portion 113, and a fourth edge portion 114, the lens L8″ may be in contact with the spacer S7. That is, in a cross-sectional view taken along the long axis LA, the flange portion 200 of the lens L8″ may be in contact with the spacer S7, and a contact point closest to the optical axis OA, among contact points, may be defined as CP2.

The distance d2 from the optical axis OA to the contact point CP2 between the flange portion 200 and the spacer S7 may be less than the maximum radius r1 of the optical portion 100 of the lens L8″, that is, an effective radius of the optical portion 100.

Accordingly, in the lens assembly 3000 of the present example embodiment, the lens L8″ may be stably supported by a support structure in the direction of the short axis SA and the direction of the long axis LA, and a support structure in the direction of the diagonal axis DA may be omitted to secure the effective diameter of the optical portion 100.

Referring to the above-described example embodiments, the lens assemblies 1000, 2000, and 3000 according to one or more example embodiments of the present disclosure may reduce a size of a lens assembly while securing performance of the lens assembly.

According to one or more example embodiments of the present disclosure, a lens assembly as described herein may be advantageous for side reduction by supporting a lens through an assembly structure formed only in regions of the lens opposing each other in a short axis direction and/or a long axis direction.

According to one or more example embodiments of the present disclosure, a lens assembly as described herein may secure a maximum area of an effective diameter of a lens within a limited size.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly comprising:
a lens including an optical portion refracting light, and a flange portion extending along a periphery of the optical portion;
a spacer in contact with the flange portion in an optical axis direction; and
a lens barrel accommodating the lens and the spacer,
wherein a distance from an optical axis to a contact point between the flange portion and the spacer is less than a maximum radius of the optical portion,
wherein the periphery of the optical portion includes an edge portion and a connection portion, and
wherein in a cross-sectional view passing through the optical axis and the connection portion, the lens is spaced apart from the spacer.

2. The lens assembly of claim 1, wherein the flange portion extends from the edge portion, and is spaced apart from the connection portion.

3. The lens assembly of claim 1, wherein the flange portion comprises sub-portions, the edge portion comprises sub-portions, and the connection portion comprises sub-portions,
wherein each flange sub-portion extends from a corresponding edge sub-portion, and
wherein each flange sub-portion is spaced apart from neighboring flange sub-portions by a connection sub-portion of the connection sub-portions.

4. The lens assembly of claim 1, wherein the optical portion has a non-circular shape in a view along the optical axis direction.

5. The lens assembly of claim 1, wherein a curvature of the edge portion is less than a curvature of the connection portion.

6. The lens assembly of claim 1, wherein the edge portion has a linear shape in a view along the optical axis direction.

7. The lens assembly of claim 1, wherein the connection portion has an arc shape in a view along the optical axis direction.

8. The lens assembly of claim 1, wherein the edge portion includes first and second edge portions opposing each other in a short axis direction of the optical portion, and third and fourth edge portions opposing each other in a long axis direction, perpendicular to the short axis direction.

9. The lens assembly of claim 8, wherein the spacer is in contact with a flange portion extending from each of the first and second edge portions, and is spaced apart from a flange portion extending from each of the third and fourth edge portions.

10. The lens assembly of claim 8, wherein the spacer is in contact with a flange portion extending from each of the third and fourth edge portions, and is spaced apart from a flange portion extending from each of the first and second edge portions.

11. The lens assembly of claim 8, wherein the spacer is in contact with a flange portion extending from each of the first to fourth edge portions.

12. The lens assembly of claim 8, wherein the connection portion includes a first connection portion connecting the first and third edge portions to each other, a second connection portion connecting the second and third edge portions to each other, a third connection portion connecting the second and fourth edge portions to each other, and a fourth connection portion connecting the first and fourth edge portions to each other.

13. The lens assembly of claim 12, wherein each of the first to fourth connection portions is spaced apart from the spacer.

14. A lens assembly comprising:
a lens barrel;
a plurality of lenses laminated in an optical axis direction within the lens barrel; and
a spacer disposed between two adjacent lenses, among the plurality of lenses,
wherein a periphery of at least one lens, among the two lenses, includes a linear-shaped edge portion and an arc-shaped connection portion,
wherein the spacer is in contact with the edge portion and is spaced apart from the connection portion in the optical axis direction, and
wherein a shortest distance from a contact point between the edge portion and the spacer to the optical axis is less than a maximum effective radius of the at least one lens.

15. The lens assembly of claim 14, wherein the at least one lens is a lens having a largest effective diameter, among the plurality of lenses.

16. The lens assembly of claim 15, wherein the at least one lens is a lens closest to an image side, among the plurality of lenses.
